(19) United States
(12) Patent Application Publication
(10) Pub. No.: US 2015/0363755 A1
(43) Pub. Date: Dec. 17, 2015

(54) METHOD AND SYSTEM FOR RESOLUTION OF DEPOSIT TRANSACTION EXCEPTIONS

(71) Applicant: PHOENIX INTERACTIVE DESIGN, INC., London (CA)

(72) Inventors: Christopher Carle Siegfried WALDEN, LONDON (CA); Mark Elgin ELSON, London (CA); Mark Anthony KOOPMAN, London (CA); Christopher James NEIL, London (CA)

(21) Appl. No.: 14/764,113

(22) PCT Filed: Jan. 31, 2013
(86) PCT No.: PCT/CA2013/000083

§ 371 Date: Jul. 28, 2015

(51) Int. Cl. G06Q 20/10

(52) U.S. Cl. CPC G06Q 20/1085

(57) ABSTRACT

A method includes receiving a request to fulfill a self-service deposit transaction on an ATM including an image scanner, the ATM connected over a network to a host device, scanning a deposit media to generate an image of the deposit media, detecting an exception in relation to the deposit transaction, generating a deposit transaction data record comprising the image and a transaction summary, and transmitting the deposit transaction data record for access by the host device enabling resolution of the exception and reconciliation of the deposit transaction.

### FIELD OF TECHNOLOGY

The present disclosure relates to automated teller machines (ATMs) including, but not limited to, methods and systems for resolution of ATM deposit transaction exceptions.

### BACKGROUND

Automated teller machines (ATMs) are in widespread use and may provide several functions to allow self-service transactions to be made by holders of electronic accounts with financial institutions such as banks, credit unions, and the like. ATMs offer several conveniences including that ATMs may be accessed at any time, and may be installed in many locations including near the premises of financial institutions, as well as gas stations, shopping malls, airports, groceries, retailers, and the like.

A range of transactions may be performed at an ATM including currency (cash or banknote) withdrawals, currency or check deposits, account balance inquiries, account transfer, payment, or maintenance activities, and the like. A plastic card with a magnetic stripe or a chip that contains a unique card number may be inserted into a card slot of the ATM, and a personal identification number or other security token may be received, in order to identify and authenticate an account.

In large scale deployments of ATMs for self-service transactions, a financial institution may use a wide variety of ATM models. Each ATM model may be differently configured and include different components such as card readers, deposit media acceptors, currency dispensers, scanners or cameras, cassettes for holding inserted deposit media, receipt printers, buttons, keypads, etc. The diversity of ATM models may lead to inconsistent acceptances of deposit media or other interactions leading to lengthy and costly deposit claims processing.

Where a self-service deposit transaction exception—such as a media jam, power failure, or other fault—occurs, the financial institution must typically devote resources and personnel to try to resolve the exception. Should the account holder submit a claim prior to existing verification and reconciliation processes being carried out, it may be difficult for the financial institution to evaluate the claim promptly and accurately, leading to delay and inconvenience for the account holder, higher costs, and other operational inefficiencies.

Improvements in ATMs and methods and systems of resolution of ATM deposit transaction exceptions are desirable.

### BRIEF DESCRIPTION OF THE DRAWINGS

Embodiments of the present disclosure will now be described, by way of example only, with reference to the attached figures, wherein:

FIG. 1 is a block diagram of an ATM in accordance with an example;

FIG. 2 is a block diagram of a system for resolution of deposit transaction exceptions in accordance with an example;

FIG. 3 is a flowchart illustrating an example of a method of transmitting a deposit transaction data record to enable resolution of a deposit transaction exception;

FIG. 4 is a flowchart illustrating an example of a method of resolution of deposit transaction exceptions using the deposit transaction data record of FIG. 3; and

FIG. 5 through FIG. 11 are views illustrating example screenshots of a deposit management system interface for use in accordance with the method of FIG. 4.

### DETAILED DESCRIPTION

The following describes a method of receiving a request to fulfill a self-service deposit transaction on an ATM including an image scanner, the ATM connected over a network to a host device, scanning a deposit media to generate an image of the deposit media, detecting an exception in relation to the deposit transaction, generating a deposit transaction data record comprising the image and a transaction summary, and transmitting the deposit transaction data record for access by the host device enabling resolution of the exception and reconciliation of the deposit transaction.

To facilitate illustration, reference numerals may be repeated among the figures to indicate similar or corresponding elements. Various details are set forth to demonstrate the examples described herein. The examples may be practiced or implemented without these details. Methods, routines, components, and parts that are well-known may not be described in detail to avoid obscuring the examples described. The description is not to be considered as confined to the scope of the examples described herein.

The disclosure relates generally to automated teller machines (ATMs) and to systems configured to be interoperable with ATMs, and to systems and methods for resolution of ATM deposit transaction exceptions as described herein.

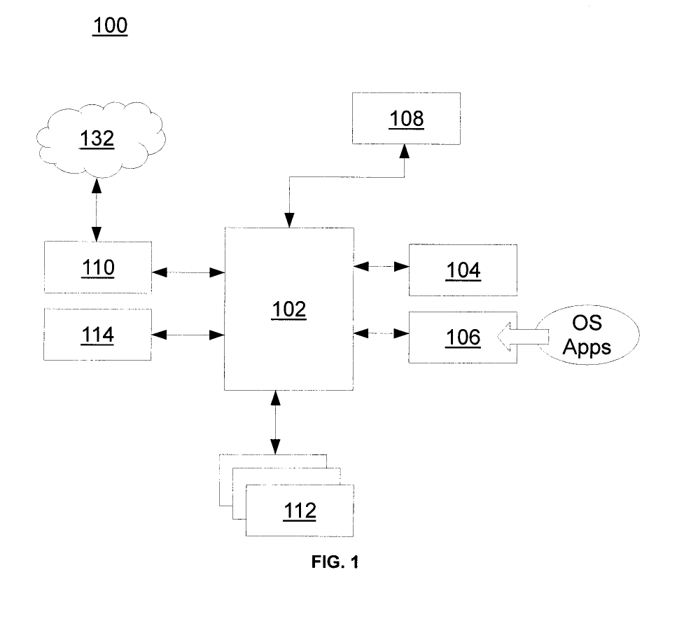

A block diagram of an example of an ATM 100 is shown in FIG. 1. According to one example, the ATM 100 (also known as an ATM terminal or an ATM installation) is a free-standing kiosk or wall-mounted device and is adapted for interior or exterior use according to the environment in which the ATM is placed. The ATM 100 permits self-service transactions to be performed by holders of electronic accounts with financial institutions such as banks. In this specification, the term “financial institution” refers to an institution that acts as an agent to provide financial services for its clients or members. Financial institutions generally, but not always, fall under financial regulation from a government authority. Financial institutions include, but are not limited to, banks, building societies, credit unions, stock brokerages, asset management firms, savings and loans, money lending companies, insurance brokerages, insurance underwriters, dealers in securities, and similar businesses.

According to one example, the ATM 100 includes multiple components such as a processor 102 that interacts with other components, such as a random access memory (RAM) 104, memory 106, a display 108, a communication subsystem 110, one or more I/O devices 112, and other subsystems 114. Information such as text, characters, images, icons, and other items may be displayed on the display 108 via the processor 102. According to one example, the I/O devices 112 include a card slot 116, a keyboard or PIN pad 118, a speaker 120, a microphone 122, and a currency dispenser 124 (shown generically as 112 on FIG. 1). According to another example, the I/O devices 112 may include an input device such as a touchpad or touch-sensitive display (not shown). One or more input devices may be included depending on the example. A power source (not shown), such as a port to an external power supply, powers the ATM 100.

Certain components or sub-systems of the ATM 100 may enable acceptance and scanning (image capture) of deposit media, such as checks, currency (banknotes), and other media. Use of the term “deposit transaction” in this specification refers to not only a transaction that places an amount for keeping in an electronic account (e.g. earning interest), but also any transaction that involves a deposit media (e.g. check cashing, funds transfer, purchase by check, etc.).

According to one example, the ATM 100 includes one or more acceptors 126 (sometimes referred to as throat acceptors) to accept deposit media including envelopes, currency, checks, or mixed media (meaning some combination of the currency and checks), paper documents, and the like (not shown).

According to one example, the I/O devices 112 include an image scanner 128 (not shown). The image scanner 128 may be configured to scan an image of each deposit media (e.g. checks) after it is inserted into the acceptor 126. An image processing engine (not shown) may provide logic to the processor 102 to analyze or manipulate the scanned image to, for example, recognize characters or text from the image (as discussed below). The image may be stored in the memory 106.

According to one example, the I/O devices 112 include a receipt printer 130 (not shown). The receipt printer 130 may print and/or dispense a receipt after a self-service transaction is completed or attempted. Alternatively, the ATM 100 may cause an electronic receipt to be forwarded to the account holder via SMS, email, or the like.

The ATM 100 includes an operating system and software programs, applications, or components that are executed by the processor 102 and are typically stored in a persistent, updatable store such as the memory 106. For example, one such application may be a terminal application that provides a user interface for the account holder to complete self-service transactions. Additional applications or programs may be loaded onto the ATM 100 through the communication subsystem 110, one of the I/O devices 112, or any other suitable subsystem 114. The processor 102 controls the overall operation of the ATM 100. Communication functions, including communications over a network 132, are performed through the communication subsystem 110.

According to an alternative example, the ATM 100 may be an electronic device, such as a desktop computer, notebook computer, tablet computer, cellular phone, smartphone, mobile device, and so forth, configured to perform transaction functions. According to this example, the ATM 100 may not include an acceptor 126. In this example, the image scanner 128 is a camera connected to the electronic device, or in other examples, is another imaging device such as a flatbed scanner, capable of creating an image of a deposit media. Use of the term “image of a deposit media” in this specification encompasses any pictorial representation of a deposit media in an electronic format.

In a traditional deposit transaction, the ATM 100 received an input for the total amount to be deposited, and received an envelope containing the deposit media (e.g., checks and currency) via the acceptor 126. Conventionally, credits for currency notes and/or checks required back-office processing, adding a hold or delay, or requiring manual teller-assistance to avoid a hold being placed on the deposit. The envelopes and enclosed deposit media were collected from a cassette in the ATM and manually processed as part of a manually intensive back-office procedure of verification and reconciliation in a branch or office of the financial institution, for example.

According to one example, the ATM 100 may receive deposit media inserted directly into the acceptor 126, without an envelope or sleeve. An image of the deposit media is captured at the time of the transaction and the deposit media may be held in a chamber or cassette (not shown) contained in the ATM 100. This technique may eliminate some of the manual processing associated with the use of deposit envelopes or sleeves, but may increase the incidence of certain deposit transaction exceptions because a scanned image of the deposit media is required.

According to one example, the acceptor 126 is a single acceptor and may be configured to accept a mixed media deposit comprising a bundle of currency (one or more banknotes) and one or more checks. The bundle may be inserted into the acceptor 126 in a single bundle or individually. The bundle may be inserted into the acceptor 126 envelope-free, meaning without the use of an envelope provided at the location of the ATM 100. Alternatively, the acceptor 126 may be a single acceptor and configured to accept a single media deposit (either currency or checks).

According to another example, acceptor 126 includes two acceptors and may be configured to accept a parallel deposit comprising a bundle of currency (one or more banknotes) and a bundle of checks (one or more checks), respectively. A parallel deposit may facilitate the processing of currency separately from checks. Each bundle may be inserted in one of the two acceptors 126 envelope-free. The ATM 100 may recognize the parallel deposit as a single deposit by prompting the account holder to insert a first bundle of currency, and then to insert a second bundle of checks (or vice versa). The bundles may be processed simultaneously (that is, in parallel) and the combined details may be displayed on the display 108 of the ATM 100 for verification. One or more acceptors may be used in accordance with examples of the invention.

The image scanner 128 may scan an image of each deposit media inserted into the acceptor 126. In some examples, the image scanner may scan an image of certain types of deposit media only, such as checks only.

The ATM 100 may be configured to display currency totals and/or a thumbnail or preview image of each scanned deposit media (e.g. checks) on the display 108 of the ATM 100 for verification by the account holder. According to one example, the receipt printer 130 may print a receipt (or forward an electronic receipt) including a transaction summary and one or more of the thumbnail images.

An application loaded on the ATM 100 may generate a deposit transaction data record 206 including a transaction summary and a thumbnail image (discussed in more detail below). The communication subsystem 110 of the ATM 100 may be configured to transmit the deposit transaction data record 206 in a message to the deposit management system 202. According to one example, the message may be transmitted on a push basis to the deposit management system 202.

According to one example, an image of a scanned check may be displayed on the display 108 of the ATM 100. Portions of the displayed image may be enlarged to permit panning and zooming in on fields of a deposit media such as the courtesy amount, legal amount, signature, etc. for a check. Panning and zooming may be facilitated by the I/O devices 112, such as buttons or other navigational inputs (e.g. left, right, up, down buttons). Alternative navigational inputs may be employed. In one example, a detail box may be displayed together with the image of the scanned deposit media, and responsive to the input, may focus on different portions of the deposit media, such as check fields like courtesy amount, legal amount, and signature. Other fields of the check, including the payor name, payor address, payee name, memo line, MICR data, date, check number, may be displayed in the detail box. Prompts may be provided to receive input to confirm or edit calculated deposit totals. In the event that the image processing engine is not able to determine the check amount, a prompt may be provided to receive an input amount from the I/O devices 112.

According to one example, images of checks and a list of currency, together with a calculated deposit total, may be displayed on the display 108 of the ATM 100 for verification by the account holder. Verification may reduce the incidence of conventional transaction exceptions such as certain keypad errors when manually typing amounts, but increase the incidence of other exceptions. For example, where currency, checks, and other media are inserted directly in the acceptor 126 of the ATM, a media jam or power failure may cause a transaction exception to occur. As well, the ATM 100 may not recognize characters or text from the deposit media correctly (discussed below). Furthermore, the account holder may make a verification error or other error, and leave the ATM with a deposit unverified or a transaction otherwise incomplete.

In one example, the ATM 100 may selectively return one or more of the deposit media to the account holder. For example, if the deposit media does not meet an image parameter threshold (as discussed below), then the check may be returned via the acceptor 126. Notwithstanding that the deposit media may be returned, the ATM 100 may generate a deposit transaction data record 206 that includes a scanned image of the deposit media, to enable resolution of deposit transaction exceptions.

According to one example, the ATM 100 may be configured to accept a forced deposit. A forced deposit permits a self-service transaction to be completed, even if a transaction exception occurs. If a transaction exception is detected, the ATM 100 may prompt for a deposit amount or total to be input, generate a deposit transaction data record 206 including a transaction summary and an image of the deposit media, and transmit the deposit transaction data record 206 to the deposit management system 202 to enable resolution of the deposit transaction exception. A print receipt containing a deposit transaction summary, together with a thumbnail image of the check, may be provided by the ATM 100. A forced deposit may reduce the need for an account holder to attempt a teller-assisted transaction, or, at least partially, provide automated means for resolving a transaction exception.

For example, if the account holder were to commence a deposit transaction and insert a mixed media bundle into the acceptor 126 of an ATM 100, but then cancel the transaction and request the bundle's return, and a fault occurs with the acceptor 126, such as a media jam or the like, then the ATM 100 may accept a forced deposit as described above. Such error handling applies to a range of transaction exceptions, including customer walkaways, media or paper jams, media insertion faults, media return faults (e.g. voluntary, prior to authorization, or after a declined authorization), image parameter failures, power failures, ATM failures, and the like. In one example, a forced deposit may be handled much like an envelope deposit, in which the deposit media is verified after the transaction, rather than issuing an IOU receipt to the account holder (which he or she may be required to take to a branch of their financial institution) or providing an error message.

In one example, a forced deposit has three stages. In the first stage of a forced deposit, the ATM 100 displays a prompt for an amount entry on the display 108 and receives an entered amount as input. In the second stage, after receiving the requested input, the ATM 100 causes a receipt to be printed by the receipt printer 130 (or in some cases, to be forwarded electronically). Although the receipt is similar to an IOU receipt, the total deposit amount has been entered. In the third stage, the ATM 100 generates a deposit transaction data record 206 including the total deposit amount entered, and transmits the deposit transaction data record 206 in a message to the deposit management system 202. In one example, the message is transmitted on a push basis, substantially immediately after an exception is detected in order to enable substantially instant resolution of the exception and reconciliation of the transaction. Receipt of the deposit transaction data record 206 may inform the deposit management system 202 of the occurrence of a forced deposit and potential deposit claim.

According to one example, a forced deposit may be triggered by one of several scenarios. For example, a media jam in the acceptor 126 or other deposit media handling component of the ATM 100 may occur during the acceptance, scanning of, and selective returning of, inserted deposit media. Where the ATM 100 does not return one or more deposit media, the ATM 100 may automatically trigger a forced deposit. A forced deposit may result in the mandatory completion of a deposit transaction following a fault or failure at the ATM 100. A failure may occur at any point in the deposit process from the insertion of deposit media, to the return of deposit media prior to a host authorization or the return of deposit media after the host declines the transaction.

In one example, the inserted deposit media may be rejected according to a hard logic rejection, a soft logic rejection, or an account holder rejection. A hard logic rejection refers to a rejection because a deposit media is rejected according to conventional authentication routines performed by components of the ATM 100. For example, a hard logic rejection may detect whether a deposit media is fake or, in the case of a check, missing a codeline. A soft logic rejection refers to a rejection because a deposit media does not meet an image parameter threshold (discussed below) that may be predetermined by the financial institution. An account holder rejection refers to an account holder selecting an option for the ATM 100 to return some of or all the inserted deposit media. It will be appreciated that, within a bundle of deposit media, some of the deposit media may be accepted, while other deposit media may be rejected.

According to one example, a forced deposit may be triggered by some combination of a hard logic rejection, a soft logic rejection, or an account holder rejection, and in some cases, a media jam. For example, an acceptor 126 may jam with currency (banknotes) during the acceptance of the banknotes or the return of the banknotes (if rejected according to a hard logic rejection, soft logic rejection, account holder rejection, or some combination). According to another example, an acceptor 126 may jam with inserted checks during the acceptance of the checks, or the return of the checks. Some of the deposit media may be accepted, while other deposit media may be rejected.

According to one example, the ATM 100 creates a deposit transaction data record 206 to capture a summary of the attempted transaction details, including the forced deposit details. The summary may be provided to the account holder on the display 108 of the ATM 100 or printed on a receipt by the receipt printer 130 (or forwarded to the account holder electronically).

According to one example, the ATM 100 includes an image processing engine to recognize and process images of deposit media (e.g., checks). For example, the image processing engine may recognize various fields of a check image, such as the Courtesy Amount/Legal Amount Recognition (CAR/LAR). The CAR determines the numerical value of the check as it appears in an amount box on the check. For example, a courtesy amount may be $100.00. The LAR, on the other hand, determines the value in words of the courtesy amount. For example, a legal amount may be “One Hundred Dollars”.

According to one example, the image processing engine evaluates one or more image parameters that may include an image quality analysis parameter, an image field presence parameter, and an image field recognition parameter. The one or more image parameters may be adjusted, according to one or more quality standards of a given financial institution.

In one example, the one or more image quality parameters may be associated with one or more thresholds. If an image of the deposit media does not meet the threshold, then the image fails the test for that parameter and the deposit media may be rejected. A higher threshold causes a greater number of checks to be rejected, at the expense of a higher incidence of valid checks being rejected incorrectly. Conversely, a lower threshold results in the acceptance of a greater number of checks, but a higher risk of accepting invalid checks requiring manually intensive back-end processing to resolve irregularities.

The image quality parameter refers to the overall readability of the image of a scanned deposit media (e.g. check), and to the presence of physical defects on a check. Examples of poor image quality are an incomplete image, an image that is either too light or too dark, and a degraded image. Examples of physical defects are missing or unreadable fields such as amount, date, codeline, the issuer's signature, or the endorsement signature in the case of a check. A check comprises several fields. The codeline on a check is a magnetic ink character recognition (MICR) value. The MICR value contains components that represent information about the payor's bank, and in some cases, the check amount. The bank information includes a bank's transit number, branch number, and institution number.

In particular, the following image quality parameters may be applied to the image of the front side of a check: undersize image, folded or torn deposit media (or document) corners, folded or torn deposit media edges, deposit media framing error, excessive deposit media skew, oversize image, piggyback deposit media, image too light, image too dark, horizontal streaks, below minimum compressed image size, above maximum compressed image size, excessive spot noise, image out of focus.

The undersize image parameter refers to the scanned image's width or height being below the minimum image size based on the minimum image size and one or more tolerances associated with the image scanner 128. This defect may develop in case of torn deposit media (a significant portion of the original source deposit media is absent), a folded deposit media (a significant portion of the original source deposit media is folded), or an improperly framed deposit media (the leading or trailing edge of the deposit media has been truncated due to a synchronization error during image scanning or capture).

The folded or torn deposit media corners parameter refers to the corner of the deposit media being either missing and/or folded in the scanned image. Maximum fold/tear width/height thresholds may be defined for each corner of the deposit media (i.e., four separate sets of width and height thresholds). This defect may develop in case of folded deposit media corners (a corner of the deposit media has been folded, causing an area of the scanned image to be missing and obscured), or torn deposit media corners (a missing corner in the deposit media, resulting in an area of the scanned image to be missing).

The folded or torn deposit media corners parameter refers to the edge of the deposit media being either missing and/or folded in the scanned image rendition. Maximum folded/torn edge width and height thresholds may be defined for each edge of the deposit media (i.e., four separate sets of width and height thresholds). This defect may develop in case of torn and/or folded deposit media edge (an edge of the deposit media has been torn and/or folded, causing an area of the scanned image to be missing and obscured).

The deposit media framing error parameter refers to the inclusion of additional vertical and/or horizontal scan lines, within the scanned image, that contain no pixel data. A maximum left/right/top/bottom edge over scan threshold may be defined. This defect may develop with the presence of additional scan lines beside the left edge (or right, top, or bottom edge) of the deposit media in the scanned image caused by the image scanner 128 not being able to properly detect the edges of the deposit media during image scanning.

The excessive deposit media skew parameter refers to the deposit media not being in proper alignment with a sensor of the image scanner 128. Maximum positive and negative skew angle thresholds may be defined. This defect may appear in cases of media handling problems in the deposit media transport (e.g. document feeder, transport belts/rollers), deposit media not properly aligned in the transport track, resulting in the deposit media being skewed as it imaged by the image scanner 128, improper alignment of the deposit media if the deposit media is imaged using a flatbed scanner.

The oversize image parameter refers to the scanned image's width or height being above the maximum image size based on a maximum image size and tolerances associated with the image scanner 128. This defect may develop in case of overlapping (piggy-backed) deposit media, meaning an image containing two or more deposit media that are overlapped as they pass the image scanner 128, under-spaced deposit media, meaning an image containing two or more deposit media that are separated by only a small distance (or end-to-end), resulting in two deposit media being captured as a single image, and skewed deposit media, meaning excessively skewed documents may cause the maximum image height to be exceeded.

The piggyback deposit media parameter refers to two or more deposit media being present and overlapped within the scanned image. This defect may be caused by document quality faults, preparation/sorting faults, and mechanical handling and control faults within a document transport feeder or track of the ATM 100.

The image too light parameter refers to an insufficient number of “black” pixels for a bi-tonal image, or a high “brightness” and low “contrast”, for gray level or color images. For bi-tonal images, a threshold may be defined as a minimum percentage of black pixels. For gray-level and color images, a minimum percentage brightness threshold and a minimum percentage average contrast may be defined. The defect may be caused by one of: poor printing/writing contrast on the deposit media, improper threshold for the document background, illumination problems with the image scanner 128, or image scanner calibration problems.

The image too dark parameter refers to the image having too many “black” pixels, for a bi-tonal image, and the image having insufficient “brightness”, for gray level or color images. For bi-tonal images, a threshold may be defined as a maximum percentage of black pixels. For gray-level and color images, a maximum percentage brightness threshold and a minimum percentage average contrast may be defined. This defect may be caused by excessive printing/writing on the deposit media, improper threshold for the deposit media background, large amounts of black pixel “noise” present in the image, illumination problems with the image scanner 128, and image scanner calibration problems.

The horizontal streaks parameter refers to the image containing one or more “dark” (for all images) or “light” (for gray level and color images) horizontal streaks that extend horizontally across the majority of the entire scanned image. A threshold may be defined as a maximum height threshold for the largest black streak (for bi-tonal images), or gray level or color streak (for gray level or color images) height detected. A further threshold may be defined as the maximum count of streaks. Dark streaks may be caused by a number of factors during the scanning of the image. Possible sources of dark streaks include the following: dirt and/or ink that may adhere to the image capture scan window or camera lens commonly present in most high, medium or low-speed document transport imaging systems, a scratch or irregularity present on the image scan window or camera lens—top or bottom, dirt or debris on camera calibration targets, i.e., white reference targets, and failure of the image camera CCD sensor or electronics.

The below minimum compressed image size parameter refers to the compressed image size being too low compared to a defined threshold. Minimum compressed image size thresholds may be independently established for the front and rear of deposit media and may be dependent on the selected image compression method. The defect may be caused by improper suppression (threshold incorrect) of the deposit media background, image camera calibration problems, inappropriate compression parameters/settings, yielding an image with a high level of distortion, a white document with very little writing or printing, e.g., the rear of an image with a small endorsement.

The above maximum compressed image size parameter refers to the compressed image size being too high compared to a defined threshold. Maximum compressed image size thresholds may be independently established for the front and rear of deposit media and may be dependent on the selected image compression method. A large compressed image packet size is generally an indicator of an image with high information content. For example, lots of writing or printing or high contrast background patterns. A large compressed image size occurs when the image contains a lot of black/white pixel transitions. This may be an indicator that the bi-tonal image has the following attributes: a significant amount of image “noise” present in the image, a large amount of written/printed data present in the image, a significant amount of the image background pattern/scene has been retained during the creation of the bi-tonal rendition.

The excessive spot noise parameter refers to an image containing “excessive occurrences” (greater than some defined count) of “spot noise” (isolated dark small pixel groups). A maximum spot noise count (average spot noise per one sq. inch area) threshold may be defined. Spot noise may be caused by one or more factors: a “cluttered” background such as a complex high contrast image—when imaged, this type of background may result in many small dark regions or noise; low contrast that produces many isolated dark regions as the image scanner 128 struggles to differentiate bright and dark portions; low contrast and subsequent noise may also occur if there is a problem with the image scanner 128 such as improper illumination; noise may result from physical defects on the deposit media; the surface of the deposit media may contain actual dark regions resulting from dirt or other contaminants.

The image out of focus parameter refers to the image scanner 128 being “out of focus” resulting in scanned images that are blurred. A minimum focus threshold may be defined. This defect may be caused by a change in the optical-mechanical settings of the image scanner 128, or the deposit media are not positioned within the “depth of focus” of the image scanner 128.

The following image quality parameters may be applied to the image of the rear side of a check: below minimum compressed rear image size, above maximum compressed rear image size, carbon strip detected.

The carbon strip detected parameter refers to the presence of a “carbonized band” that typically extends from the leading edge to trailing edge on the rear of the image. This defect may potentially interfere with the legibility of endorsements. A threshold may be defined to detect the presence of a black band on the rear of the image that meets the size and location requirements for a carbonized band, and to compare the black band to a minimum height.

The following image quality parameters may be applied to the images of both sides of a check: front to rear image dimension mismatch.

The front-rear image dimension mismatch parameter refers to the scanned image height and width not matching between the front and rear images of the deposit media. A maximum image width/height difference threshold may be defined in comparison to an absolute value of the image width/height difference. This defect may be caused by the front image of deposit media “n” being matched up with the rear image of deposit media “n−1”, or differences in deposit media framing for the front and rear images.

If the check images are compressed, for example in a TIFF format, then the following image quality parameters may be applied: below minimum compressed front image size, above maximum compressed front image size, below minimum compressed rear image size, above maximum compressed rear image size.

Furthermore, the one or more image field presence parameters may be associated with one or more thresholds. If the image of the deposit media does not meet the threshold (e.g., a required check field is detected to be missing, or does not contain usable information), then it may be rejected.

The following deposit media image field presence parameters may be applied to the image of the front side of a deposit media such as a check: courtesy amount presence, legal amount presence, date presence, payee name presence, signature presence, codeline presence, payor name and address presence, memo line presence, payor bank name presence.

The following image field presence parameters may be applied to the image of the rear side of a deposit media such as a check: payee endorsement presence.

According to one example, an image field presence parameter is either enabled or disabled for each field of a deposit media, such as a check. The parameter may be evaluated according to a confidence score in the range zero (0) to one thousand (1000), for example. A default acceptable score or threshold may be five hundred (500), in this example.

Furthermore, the one or more image field recognition parameters may be evaluated. If the image of the deposit media does not meet the threshold (i.e., a required deposit media field is not recognized), then it may be rejected.

The following image field recognition parameters may be applied to the image of the front side of a deposit media such as a check: codeline and amount.

According to one example, an image field recognition parameter may be evaluated according to a confidence score in the range zero (0) to one thousand (1000), for example. A default acceptable score or threshold may be seven hundred (700), in this example. A low score implies that the check amount may not be recognized (and require verification). A high score implies that the check amount is recognized.

The ATM 100 may include hardware or software components to process the images of scanned checks to automatically correct some of the image parameters discussed above. For example, the ATM 100 may cause images of deposit media to be cleaned, de-slanted, and cause writings on the image to be segmented into words, numerals, and characters prior to evaluating the image parameters for acceptance or rejection.

The above examples apply to checks primarily and should be seen as illustrative and exemplary; other image parameters may be applied according to any technique known to those skilled in this art. Different image parameters may be applied to different deposit media, such as currency (banknotes). As well, a greater or a fewer number of image parameters, and associated thresholds, may be used.

As mentioned, the image parameters may be adjusted, or tuned, to increase the acceptance of deposits at the ATM 100 to avoid scenarios where a deposit media is rejected at the ATM 100 but a teller would accept the same media.

According to one example, the deposit management system 202 may provide functionality to process a batch of images from a bundle of deposit media that are known to be acceptable, in order to seed the image parameter thresholds. In other examples, the image parameter thresholds may be pre-determined by the financial institution.

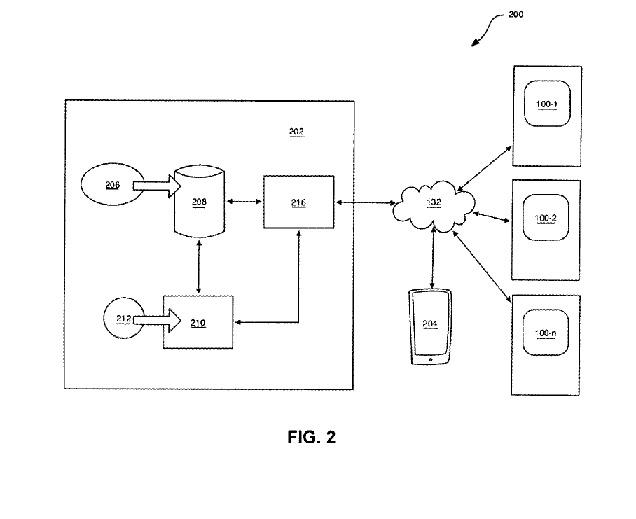

A block diagram of an example of a system 200 for resolution of ATM deposit transaction exceptions is shown in FIG. 2. The system 200 includes one or more ATMs 100, one or more host devices 204 (the example of FIG. 2 illustrates one host device 204 for simplicity), and a deposit management system 202.

According to one example, the deposit management system 202 includes multiple components such as a processor 210 (not shown) that interacts with other components, such as a random access memory (RAM) 226 (not shown), memory 214 (not shown), a communication subsystem 216 (not shown), and other subsystems 218 (not shown). A deposit management system 202 includes an operating system and software programs, applications, or components that are executed by the processor 210 and are typically stored in a persistent, updatable store such as the memory 214. Additional applications or programs may be loaded onto the deposit management system 202 through the communication subsystem 216, or any other suitable subsystem 218. The processor 210 controls the overall operation of the deposit management system 202. Communication functions, including communications over the network 132, are performed through the communication subsystem 216.

The communication subsystem 216 receives messages from and sends messages to a communication subsystem 110 of the ATM 100 via the network 132 and/or a communication subsystem of the host device 204.

In one example, the deposit management system 202 is configured to perform several functions. The deposit management system 202 communicates with the one or more ATMs 100 to receive a plurality of messages including deposit transaction data records 206, maintains a data storage 208 of the deposit transaction data records 206, and sends messages to the host device 204 for resolution of ATM deposit transaction exceptions.

The data storage 208, which may be memory 214 in one example, maintains a plurality of deposit transaction data records 206. In one example, a record processing engine 212 provides logic to the processor 210 to transmit the deposit transaction data records 206 to the host device 204. According to one example, the data storage 208 may be a database management system that processes all data requests between a host device 204 and the deposit management system 202. According to this example, the data requests between the data storage 208 and the deposit management system 202 may be made over a secure network connection.

In one example, the data storage 208 is a stand-alone database server (such as Microsoft™ SQL Server™) that may be co-located with the deposit management system 202, or alternatively may be geographically dispersed. In some examples, the data storage 208 may be a stand-alone physical server, and in other examples, may be a virtual machine.

According to one example, the one or more ATMs 100 may send messages including deposit transaction data records 206 to the deposit management system 202 over the network 132. According to one example, the messages from the ATMs 100 may be pushed, meaning that requests for a given transaction (e.g. sending and receiving a message) are initiated by the “publisher” (such as the ATM 100), in contrast to messages that are pulled, meaning that requests for a given transaction (e.g. sending and receiving a message) are initiated by the “receiver” (such as the deposit management system 202).

After a transaction is attempted at the ATM 100, information about the transaction may be generated, consolidated, and parsed in one or more applications or routines that are executed by one of the processors 102 or 210, for example. The information may be formatted in a deposit transaction data record 206 that is sent in a message (e.g. pushed) to the deposit management system 202. Upon receipt of the message including the deposit transaction data record 206, the deposit management system 202 may parse the message, and store the deposit transaction data record in the data storage 208 (or data management system that is configured to have the functionality of the data storage 208). The data storage 208 may include an operational data store (an intermediate data warehouse), and a data warehouse store. According to one example, the deposit transaction data records 206 may be received by the deposit management system 202, stored in the operational data store for consolidating, and passed to the data warehouse store for archiving and reporting. Various extract, transform, and load (ETL) operations may be performed on the deposit transaction data records 206 to consolidate the deposit transaction data records 206 before being passed to the warehouse data store. Although one particular implementation of the data storage 208 has been illustrated, the data storage 208 may be implemented using one or more servers and databases to implement other examples of the invention.

According to one example, the host device 204 may send and receive queries related to the deposit transaction data records 206 to and from the deposit management system 202 over the network 132. In this example, a client application on the host device 204 may pull, or request, deposit transaction data records 206 on demand through a message over the network 132 to the deposit management system 202. In one example, the message may be a web service call, though other network architectures and/or protocols may be used.

The messages between the one or more ATMs 100, the deposit management system 202, and the host device 204, may be sent or received over the network 132 using a secure network connection, such as a secure TCP/IP connection. The messages may be sent and received by the respective communications subsystems 110, 216, and, as discussed below, 230. In one example, some of or all the messages may be sent using SSL secure communication transmissions. For example, messages including deposit transaction data records 206 (as discussed below), may be sent using SSL secure communication transmissions or other techniques such as public/private key cryptography.

The network 132 may be any type of communications network such as a wired or wireless network. The network 132 may be a private network or a public network. Messages sent over the network 132 may be encrypted or otherwise secured.

The host device 204 provides a management interface for the deposit management system 202. In one example, the host device 204 is an electronic device, such as a desktop computer, notebook computer, tablet computer, cellular phone, smartphone, mobile device, and so forth, configured to provide a management interface that sends queries to the deposit management system 202. According to this example, the host device 204 includes multiple components such as a processor 220 (not shown) that interacts with other components, such as a random access memory (RAM) 222 (not shown), memory 224 (not shown), a display 224 (not shown), one or more I/O devices 228 (not shown), a communication subsystem 230 (not shown), and other subsystems 232 (not shown). Information such as text, characters, images, icons, and other items may be displayed on the display 224 via the processor 220. In one example, the host device 204 includes an operating system and software programs, applications, or components that are executed by the processor 148 and are typically stored in a persistent, updatable store such as the memory 152. Additional applications or programs may be loaded onto the host device 204 through the communication subsystem 160, or any other suitable subsystem 162. The processor 148 controls the overall operation of the host device 204. Communication functions, including communications over the network 132, are performed through the communication subsystem 110. Although one example of a host device 204 has been illustrated, a host device 202 may be any other device that permits queries to be made of the deposit transaction data records 206.

The deposit management system 202 may be connected to external systems that route financial transactions to other systems of the financial institution (such as item processing systems), and the systems of other financial institutions.

It will be appreciated that, according to some examples, functions of the deposit management system 202 may be carried out on the host device 204, and the deposit management system 202 may be integrated with the host device 204.

Upon receipt of a deposit claim, an analyst using the host device 204 may confirm the deposit transaction by comparing an entered amount to an image of the deposit media, as shown in a deposit transaction data record 206.

An application on the host device 204 (e.g., used by an analyst in the claims management department or ATM operations department of a financial institution) may submit a query to view a deposit transaction data record 206 for a given date range, and, optionally, for a specific ATM 100. The query may be sent to the deposit management system 202. The data storage 208 is queried, or, according to some examples, the query may be forwarded to a separate database management system (not shown) that has the functionality of the data storage 208. The deposit management system 202 then forwards the response to the query to the application on the host device 204.

According to one example, a deposit transaction data record 206 includes a transaction summary, an image of a deposit media, a receipt image, and one or more image parameter test results. The one or more image parameters may include an image field recognition parameter, an image field presence parameter, and an image quality analysis parameter.

The transaction summary includes details regarding the transaction, including transaction date, transaction time, transaction ID, a sequence ID (e.g. generated by an authorization subsystem of the financial institution), and deposit media details. According to one example, all deposit media from the same transaction have the same transaction ID. Deposit media details, such as check details, may be determined from the codeline (e.g., transit number, check number). Deposit media details may include one or more status codes indicating whether the deposit media was inserted, accepted, returned, captured by the ATM 100. Deposit media details may include a detailed breakdown of the currency note denominations, where the deposit media is currency.

The one or more image parameter test results may provide information regarding the acceptance or rejection of the deposit media, and may provide a transaction history for each deposit media inserted in the ATM 100.

According to one example, the deposit transaction data record 206 may be saved to the data storage 208 at the end of a customer session. Alternatively, the deposit transaction data record may be saved with the completion of each transaction, or in parts during the completion of a transaction.

The deposit transaction data record 206 may include a receipt image that reproduces a printed receipt or a displayed receipt that is provided to an account holder by the ATM 100, to enable the resolution of deposit transaction exceptions.

An example deposit transaction data record 206 may be defined by the fields given in the following Tables. In one example, the deposit transaction data record 206 may be encoded as an XML document. While numerous fields are shown in the tables below, those skilled in the relevant art will appreciate that fewer or more fields may be used. The fields, types, and descriptions may be changed to fit the financial institution's individual needs. Furthermore, one example is shown; numerous other implementations may be used.

TABLE 1
Core Transaction Data

| Field | Type | Description |
|---|---|---|
| Transaction Type | Int | Transaction type identified by ATM 100. |
| | | This may ensure that all transactions of the |
| | | same type (e.g. check deposit) are identified. |
| Transaction | String | Business function name. This may be |
| Name | | formatted as an editable string. |
| DateTime | String | Local terminal time. The date and time may |
| | | be in the format 'yyyyMMddHHmmssfff'. |
| | | For example, ′20130128150428729′. |
| DateTime | String | Local terminal time. The date and time may |
| (alternative) | | be in the format ′yyyy-MM-dd HH:mm: |
| | | ss.fff zzz′. For example, ′2013-01-28 |
| | | 15:04:28.925 +05:00′. |
| Global | Guid | Globally unique identifier for the |
| Transaction ID | | transaction in the format xxxxxxxx-xxxx- |
| | | xxxx-xxxx-xxxxxxxxxxxx. |
| Terminal | Int | Transaction ID assigned by a terminal |
| Transaction ID | | application on the ATM 100. This may not |
| | | be globally unique. |
| Host Transaction | String | Transaction ID assigned by a financial |
| ID | | institution sometimes referred to as sequence |
| | | number. This may not be globally unique. |
| Session ID | Long | ID of a session. |
| Card Number | String | Account holder card number. |
| Host Result | String | Interpreted result value provided by a |
| | | financial institution system (RARI code). |
| | | The format is 6 digits. |
| Terminal | Int | Status of the transaction assigned by a |
| Transaction | | terminal application on the ATM 100. |
| Status | | |
| Resolution | Bool | Whether the transaction requires manual |
| Required | | resolution. This may be set in cases such as |
| | | forced deposits and power failures, etc. In |
| | | the forced deposit case, it may be set on |
| | | both the forced deposit transaction and the |
| | | parent deposit transaction. It may not be set |
| | | on the parent linked deposit transaction. |
| Amount | Decimal | Amount value of the transaction. |
| Parent | Guid | ID of the parent transaction, if applicable. |
| Transaction ID | | This may link a forced deposit transaction |
| | | to its parent deposit transaction, and it may |
| | | link individual deposit transactions to |
| | | parent linked deposit transactions. In an |
| | | alternative example, this may |
| | | link to a session-level transaction. |

TABLE 2
Receipt Data

| Field | Type | Description |
|---|---|---|
| Receipt Type | Int | Type of the receipt (e.g. Normal, |
| | | Forced Deposit). |
| Delivery Type | Int | Delivery type of the receipt (e.g. |
| | | Email, Print, SMS). |
| Page Number | Int | 1-based receipt page number. |
| Image Type | String | Image type. E.g., TIF. |
| Receipt Image | Binary | Base64-encoded binary receipt |
| | | image data. The receipt image may |
| | | be a monochromatic TIF image. |

TABLE 3
Tracked Interactions Data

```
<?xml version=“1.0” encoding=“utf-16”?>
<transactionEvents>
      <transactionEvent>
            <teCode>Transaction event code</teCode>
            <time>time</time>
            <params>
                  <param>Parameter value</param>
                  <param>Parameter value</param>
            </params>
      </transactionEvent>
</transactionEvents>
```

| Field | Type | Description |
|---|---|---|
| Transaction | String | Unique code for each transaction event. |
| event code | | |
| Time | String | UTC time. The date and time may be in the |
| | | format ‘yyyy-MM-dd HH:mm:ss.fff zzz’. For |
| | | example, ‘2013-01-28 15:04:28.925 +05:00’. |
| Parameter | String | Value of the parameter being passed e.g., |
| value | | username or check number etc. If there are no |
| | | parameters for the transaction event, the params |
| | | element may be omitted. |

TABLE 4
Check Summary Data

| Field | Type | Description |
|---|---|---|
| Scan Order | Int | 1-based index that identifies the order in |
| | | which the checks were scanned. |
| Recognized | Decimal | Check amount that was automatically |
| Amount | | recognized. |
| Entered Amount | Decimal | Check amount that was manually entered. |
| Codeline | String | Recognized codeline value. |
| Rejected By | Int | Identifies the authority that rejected the check. |
| Check Status | Int | Status of the check. |
| Front Image | String | Front image type. E.g., TIF. |
| Type | | |
| Front Image | Binary | Base64-encoded binary front of check image |
| | | data. The front of check image may be a |
| | | monochromatic TIF image. |
| Back Image Type | String | Back image type. E.g., TIF. |
| Back Image | Binary | Base64-encoded binary back of check image |
| | | data. The back of check image may be a |
| | | monochromatic TIF image. |

TABLE 5
Check Codeline Data

| Field | Type | Description |
|---|---|---|
| Codeline Part | String | Name of the codeline data field. |
| | | This may be sent as a string. |
| Value | String | Value of the field. |

TABLE 6
Check Test Result Data

| Field | Type | Description |
|---|---|---|
| Test | Int | Test identifier. |
| Score | Int | Test score if the test assigns a score. |
| Threshold | Int | Test threshold value, if applicable to the test. |
| Pass | Bool | Whether the test passed, or blank if it was |
| | | not run. |
| Rejected | Bool | Whether the test result resulted in the check |
| | | being rejected. |
| Value | String | Recognized value (applicable only to |
| | | recognition tests). |

According to one example, the ATM 100 is configured to electronically transmit, on a push basis, messages including deposit transaction data records 206 to the deposit management system 202 for access by the host device 204 (e.g., at a claims department of the financial institution). The host device 204 may be notified, including by email notification or other electronic communication, of a pending reconciliation action or potential deposit transaction claim. In one example, the transmission of several deposit transaction data records 206 to the deposit management system 202 may be batched, rather than sent substantially immediately after an exception is detected or a transaction is completed.

The deposit management system 202 maintains the deposit transaction data records 206 for access by the host device 204 to facilitate resolution of deposit claims related to exceptions such as forced deposits. Deposit claims may be resolved more promptly, and at least in a partially automated fashion, with the benefit of the information contained in the deposit transaction data record 206, such as the image parameter test results, without requiring a manual teller-assisted deposit transaction. The deployment of the one or more ATMs 100, deposit management system 202, and host device(s) 204, according to the methods herein may reduce costs inherent to manually processing deposit transactions and deposit media.

Upon receipt of the deposit transaction data record 206 at the host device 204, the transaction exception may be resolved with the benefit of the deposit transaction data record 206 that exposes details of the deposit transaction including particulars of acceptance, rejection, an image capture of deposit media and detailed reasons for any faults.

According to one example, the host device 204 displays a deposit transaction summary including details on number of deposits, and an image of deposit media (e.g. check). The host device 204 may display the number of forced deposits to facilitate ready identification of transactions with potential deposit claims.

According to one example, a deposit transaction exception summary view is displayed on the host device 204 after a client application is loaded on the host device 204. The summary view may include details of why a particular deposit media was accepted or rejected. The summary view may provide the host device 204 with functions to review or audit metrics such as deposit transaction service time, transaction performed, and so on.

In a further embodiment of the invention, the ATM 100 includes a tracking engine (not shown) that provides logic to the processor 102 to track interactions with the ATM 100 throughout a self-service transaction. The tracked interactions may be included as part of the deposit transaction data record 206 generated by the ATM 100 and transmitted to the host device 204. The tracked interactions may include customer selections and customer-initiated actions as well as ATM-level actions. Tracking of these interactions enables resolution of deposit exceptions by enriching the deposit transaction data record 206 to reveal the account holder's interactions at the ATM 100 that led to or caused the transaction exception. For example, the tracked interactions may provide the host device 204 with details of what happened prior to a power failure scenario, assisting with reconstructing the attempted deposit transaction. The tracked interactions (also known as sequence details), contained in the deposit transaction data record 206, may be electronically transmitted in a message on a push basis to the deposit management system 202 for inspection by the host device 204.

In one example, the deposit management system 202 includes an analytics engine (not shown) that provides logic to the processor 210 to provide the host device 204 with business intelligence derived from the data storage 208. Queries of the deposit transaction data records 206 may be made from the host device 204 to derive business intelligence information regarding a sample set of deposit transaction data records 206. Data-mining may yield trends or metrics used to set or adjust the image parameters discussed above, or for performance management reasons.

For example, a financial institution that experiences a large number of false check rejections may query the deposit transaction data records 206 to discover that the rejections were caused by a failed field presence parameter test (e.g. signature missing). If it is determined that the signatures were present, but incorrectly reported as missing or absent, then it may be that the field presence parameter threshold for the ATM 100 (or the particular model of ATM, etc.) is too sensitive, and may be adjusted to automatically accept a greater number of checks, ensuring that an optimal level of checks may be accepted for the ATM 100.

According to one example, the ATM 100 includes a rescan engine (not shown) that provides logic to the processor 102 to process a bulk scan of deposit media from the cassette of the ATM 100. For example, a technician dispatched to service an ATM 100 may empty the cassette and insert the bundle of currency (banknotes), checks, or mixed media, into the acceptor 126 of the ATM 100. Rescanning checks at the site of the ATM 100 may eliminate the need for manual back-end check scanning and may permit the deposit transaction data record 206 to be updated with a re-scan image, should the deposit transaction data record 206 be missing the information as a result of a media jam, for example. Rescanning at the site of the ATM 100 may enrich the deposit transaction data record 206 with a re-scan image and facilitate resolution of deposit transaction exceptions. The transmission of messages including deposit transaction data records 206 may enable timely dispute resolution, permit operational efficiencies to be achieved as well as cost effective management of a plurality of different ATMs from a variety of vendors.

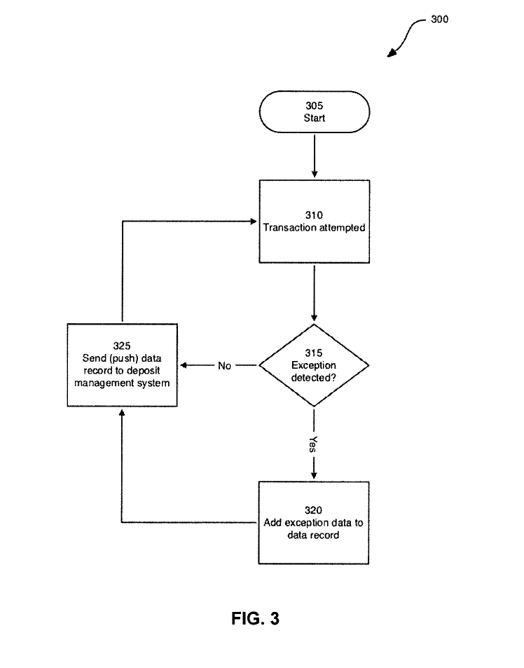

A flowchart illustrating an example of a disclosed method of transmitting a deposit transaction data record to enable resolution of a deposit transaction exception is shown in FIG. 3. This method may be carried out by software executed by, for example, the processor 102. Coding of software for carrying out such a method is within the scope of a person of ordinary skill in the art given the present description. The methods may contain additional or fewer processes than shown and/or described, and may be performed in a different order. Computer-readable code executable by at least one processor of the ATM 100 to perform the methods may be stored in a computer-readable storage medium, such as a non-transitory computer-readable medium.

The method starts at 305, and at 310, a self-service transaction at the ATM 100 is attempted. For example, a deposit media consisting of check A is inserted into the acceptor 126 of the ATM 100. In this example, check A is missing a legal amount. The ATM 100 may scan check A to create an image B, and then perform one or more image parameter tests on the image B; if one or more tests fail, then a transaction exception is detected at 315. In this case, the image B fails the legal amount presence test because, in this example, the minimum threshold to pass the legal amount presence test may be, e.g., five hundred (500), but the legal amount presence parameter for the image B as tested is zero (0). After the transaction exception has been detected, a deposit transaction data record 206 is created at 320. The deposit transaction data record 206 contains a summary of the attempted ?0 transaction, and a copy of the image B. At 325, the ATM 100 causes the deposit transaction data record 206 to be electronically transmitted, on a push basis, to the deposit management system 202.

According to an alternative method, after the transaction exception is detected, the check A may be returned to the account holder. However, if a media jam occurs ?5 such that the check A cannot be returned to the account holder, then a forced deposit may be triggered and the account holder may be prompted to input an amount for deposit. In this scenario, the deposit transaction data record 206 includes the forced deposit amount and, according to one example, tracked interactions, in order to facilitate deposit claim resolution and reconciliation.

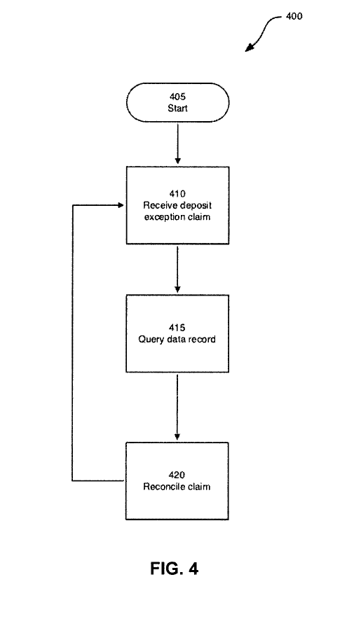

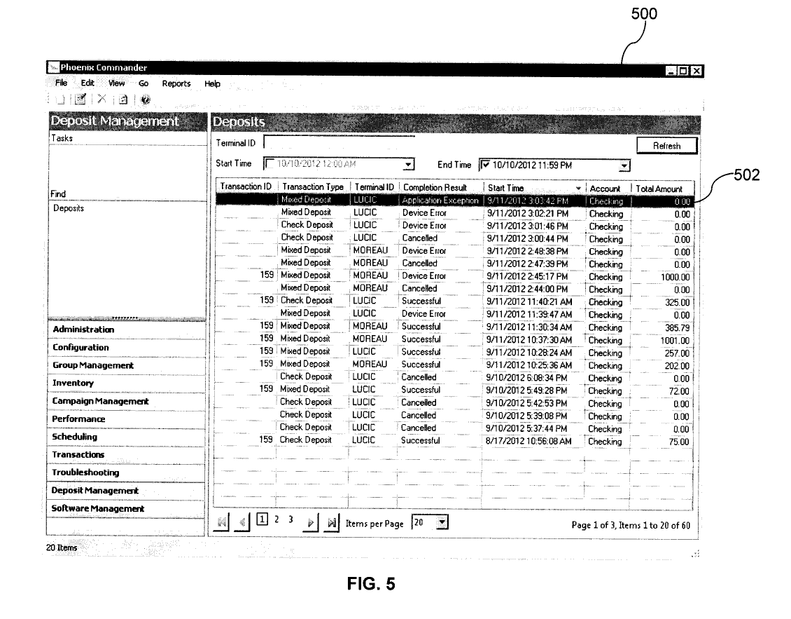

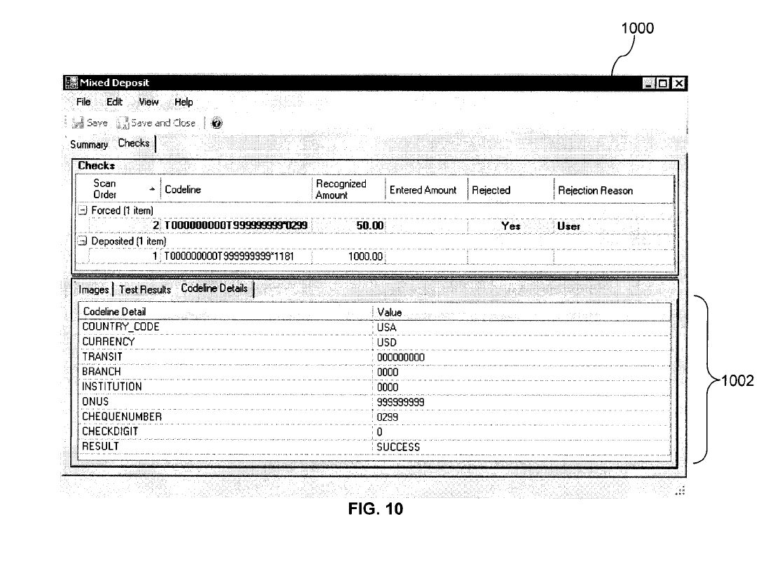

A flowchart illustrating an example of a disclosed method of resolution of a deposit transaction exception is shown in FIG. 4. The process starts at 405, and at 410, the host device 204 is processing a received deposit claim regarding a deposit transaction that was attempted but not successful. At 415, the host device 204 queries the deposit management system 202 for the deposit transaction data record 206 that pertains to the attempted transaction. The deposit transaction data record 206 provides the host device 204 with information, including an image of the deposit media, to enable resolution of the deposit claim. The host device 204 may provide an improved deposit management system interface, as will be described with reference to FIG. 5 through FIG. 11.

Examples of screenshots on the display of the host device 204 when loaded with an application to operate in accordance with the present disclosure are depicted in FIG. 5 through FIG. 11 and described with continued reference to FIG. 4.

With reference to FIG. 5, screenshot 500 may be launched by opening a client application on the host device 204. A listing of all transactions is shown, organizing one or more data fields representing the deposit transaction data records 206 into columns such as Transaction ID, Transaction Type, Terminal ID, Completion Result, Start Time, Account, Total Amount, and rows for each transaction. Other data fields may be displayed according to the content of the deposit transaction data record 206. The listing may be filtered by Terminal ID, date range, among other filters. Screenshot 500 includes a highlighted row 502. Upon receipt of a deposit claim at 410, the application may be launched on the host device 204 which queries deposit transaction data records 206 maintained by the deposit management system 202 at 415 to assist with reconciling claims at 420.

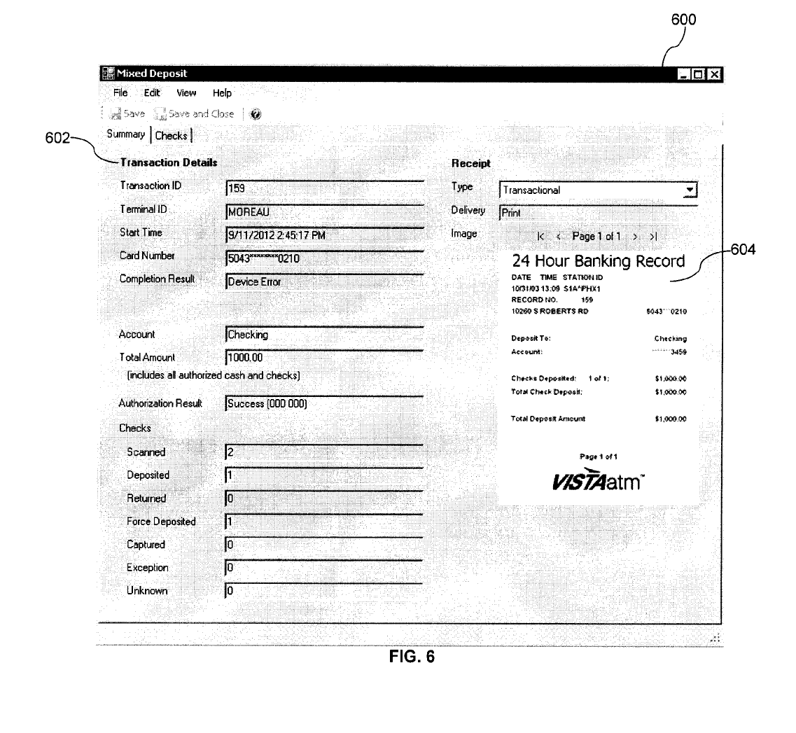

Turning to FIG. 6, screenshot 600 may be launched by double-clicking or otherwise selecting one of the rows (transactions) shown in screenshot 500. Screenshot 600 includes one or more details 602 for a selected transaction of the listing of FIG. 5, and a receipt image 604. Screenshot 700 provides information for a successful transaction. Although the examples refer to checks, the application loaded on the host device 204 may be configured to handle any deposit media transaction including currency deposits.

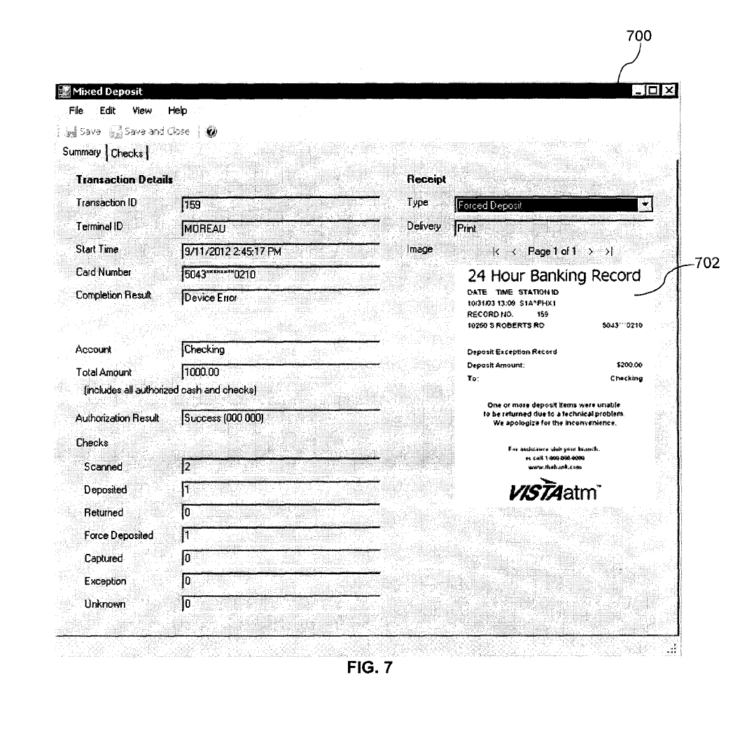

Now with reference to FIG. 7, screenshot 700 provides information for a forced deposit transaction. In particular, the receipt image 702 indicates that “one or more deposit items were unable to be returned”. Screenshot 700 provides an overview of information needed by an analyst at a financial institution to resolve a deposit claim. In this case, the forced deposit transaction information has been made available for access by the host device 204 substantially immediately after the transaction was attempted, permitting the analyst to resolve the claim, reconcile the correct amount of the transaction, and optionally to remove or amend a hold placed on the deposit.

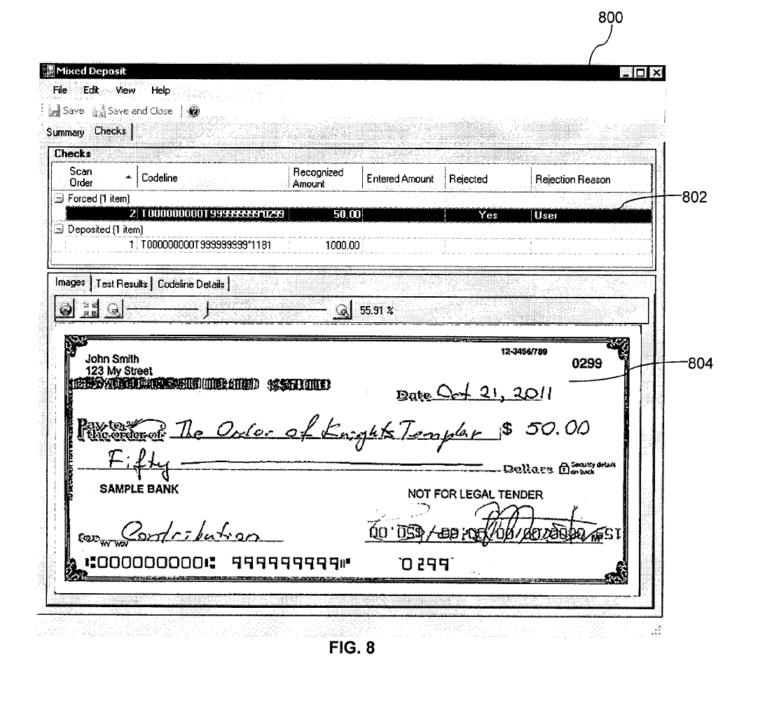

Screenshot 800 of FIG. 8 provides additional detail for the forced deposit transaction of FIG. 7. Screenshot 800 may be opened upon receipt of input selecting the “Checks” tab of FIG. 7. Screenshot 800 provides an itemized list of the checks. An entry of the list may be highlighted, as shown by 802, and an image of the check may be displayed at 804.

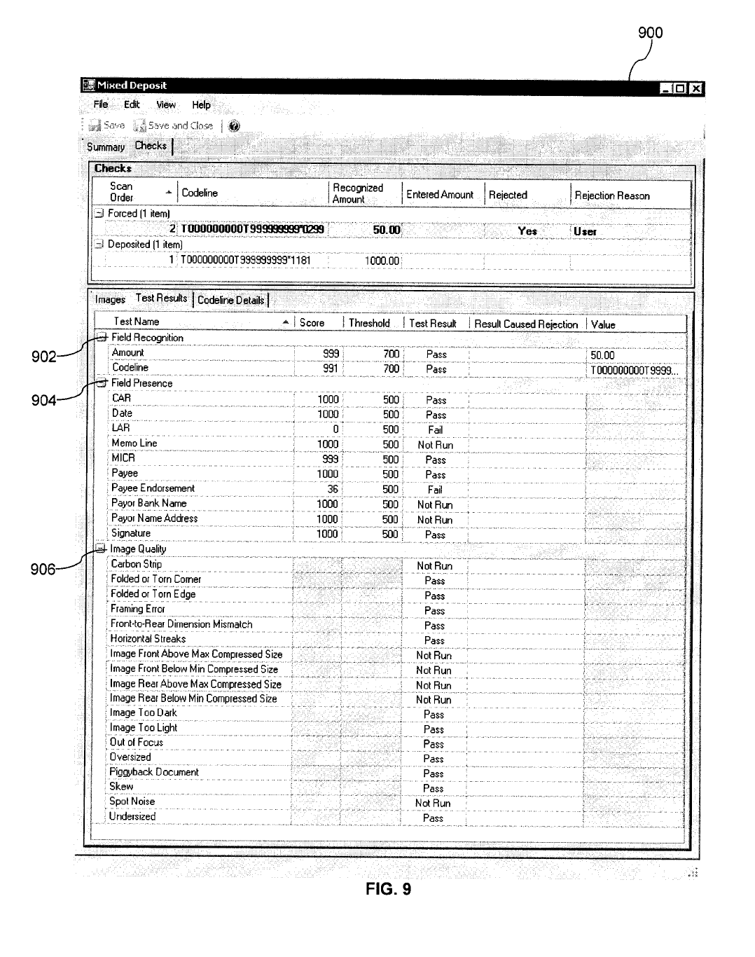

Screenshot 900 of FIG. 9 and screenshot 1000 may be opened by receiving input selecting a “Test Results” tab, or a “Codeline Details” tab of FIG. 8, respectively. Screenshot 900 provides a detailed image parameter test results. At 902, image field recognition parameters (scores, thresholds, pass/fail, and values) are displayed. At 904, image field presence parameters are displayed. At 906, image quality parameters are displayed for the selected check. Screenshot 1000 provides a summary of the codeline details, at 1002, for the selected check.

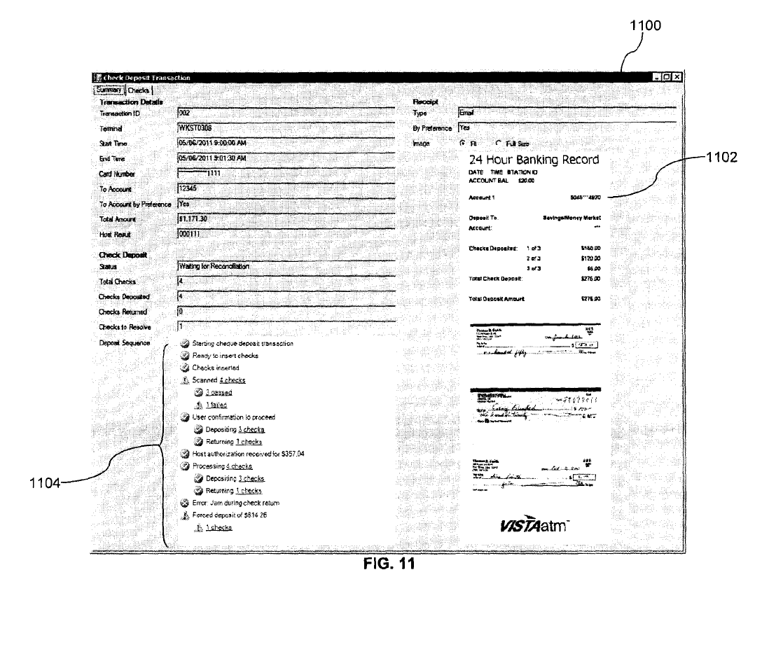

Turning to FIG. 11, screenshot 1100 includes transaction details for the selected transaction, including a receipt image 1102, and tracked interactions (or sequence data) 1104. The display of tracked interactions 1104 may be used to assist the analyst in determining the sequence of events that led to or caused a transaction exception to occur.

A method includes receiving a request to fulfill a self-service deposit transaction on an ATM including an image scanner, the ATM connected over a network to a host device, scanning a deposit media to generate an image of the deposit media, detecting an exception in relation to the deposit transaction, generating a deposit transaction data record comprising the image and a transaction summary, and transmitting the deposit transaction data for access by the host device enabling resolution of the exception and reconciliation of the deposit transaction.

A system for resolution of deposit transaction exceptions includes a deposit management system including a data storage maintaining a plurality of deposit transaction data records, a communication subsystem for communicating over a network with one or more ATMs, and a processor coupled to the data storage and the communication subsystem, wherein the processor is configured to respond to queries of the data storage received at the communication subsystem. Each ATM includes a display, an image scanner, an input device, an ATM communication subsystem, and a processor coupled to the display, the image scanner, the input device, and the ATM communication subsystem, wherein the processor is configured to receive a request to fulfill a self-service deposit transaction, scan a deposit media to generate an image of the deposit media, detect an exception in relation to the deposit transaction, generate a deposit transaction data record comprising the image and a transaction summary, and transmit the deposit transaction data record to the deposit management system. The deposit transaction data record may include tracked interactions.

The deposit transaction record may be transmitted on a push basis to a deposit management system and the method may further include querying the deposit management system for the deposit transaction record. The transmitting may occur substantially immediately after the detecting the exception enabling substantially instant resolution of the exception and reconciliation of the transaction.

The method may further include printing or displaying a receipt for the deposit transaction, and the deposit transaction data record may include a copy of the receipt for the deposit transaction.

The ATM may be an electronic device configured to perform functions of the ATM.

The ATM may include an acceptor for deposit media, and the exception may be a forced deposit exception. The deposit media may include checks and currency notes. The ATM may include a cassette in communication with the acceptor for holding deposit media, and the method may further include re-scanning deposit media held in the cassette using the image scanner to generate a re-scanned image of the deposit media, and updating the deposit transaction data record with the re-scanned image of the deposit media.

The detecting the exception step may be based on one or more image parameter test results where the image parameter is one or more of a field recognition parameter, a field presence parameter, and an image quality parameter. The image parameter may be adjusted.

A system for resolution of deposit transaction exceptions includes a deposit management system that includes a data storage that maintains a plurality of deposit transaction data records, a communication subsystem for communicating over a network with one or more ATMs, and a processor coupled to the data storage and the communication subsystem. The processor is configured to respond to queries of the data storage received at the communication subsystem. Each ATM includes a display, an image scanner, an input device, and an ATM communication subsystem. The ATM processor is coupled to the display, the image scanner, the input device, and the ATM communication subsystem. The ATM processor is configured to receive a request to fulfill a self-service deposit transaction, scan a deposit media to generate an image of the deposit media, detect an exception in relation to the deposit transaction, generate a deposit transaction data record comprising the image and a transaction summary, and transmit the deposit transaction data record to the deposit management system.

The present disclosure may be exemplified in other particular forms without departing from its essential characteristics. The described embodiments are to be considered in all respects only as illustrative and not restrictive. The scope of the present disclosure is, therefore, not intended to be restricted by the foregoing but is instead defined by the claims attached hereto.

What is claimed is:

1. A method comprising:
on an ATM comprising an image scanner, the ATM connected over a network to a host device, receiving a request to fulfill a self-service deposit transaction;
scanning a deposit media to generate an image of the deposit media;
detecting an exception in relation to the deposit transaction;
generating a deposit transaction data record comprising the image and a transaction summary; and
transmitting the deposit transaction data record for access by the host device enabling resolution of the exception and reconciliation of the deposit transaction.

2. A method according to claim 1, wherein the deposit transaction record is transmitted on a push basis to a deposit management system and the method further comprises querying the deposit management system for the deposit transaction record.

3. A method according to claim 3, wherein the transmitting occurs substantially immediately after the detecting the exception enabling substantially instant resolution of the exception and reconciliation of the transaction.

4. A method according to claim 1, wherein the deposit transaction data record further comprises tracked interactions.

5. A method according to claim 1, further comprising printing or displaying a receipt for the deposit transaction, and wherein the deposit transaction data record further comprises a copy of the receipt for the deposit transaction.

6. A method according to claim 1, wherein the ATM is an electronic device configured to perform functions of the ATM.

7. A method according to claim 1, wherein the ATM comprises an acceptor for deposit media, and the exception is a forced deposit exception.

8. A method according to claim 7, wherein the deposit media comprises checks and currency notes.

9. A method according to claim 7, wherein the ATM comprises a cassette in communication with the acceptor for holding deposit media, the method further comprising:
re-scanning deposit media held in the cassette using the image scanner to generate a re-scanned image of the deposit media; and
updating the deposit transaction data record with the re-scanned image of the deposit media.

10. A method according to claim 1, wherein the detecting the exception is based on one or more image parameter test results where the image parameter is selected from one or more of a field recognition parameter, a field presence parameter, and an image quality parameter.

11. A method according to claim 10, wherein the image quality parameter comprises one or more of: undersize image, folded or torn deposit media (or document) corners, folded or torn deposit media edges, deposit media framing error, excessive deposit media skew, oversize image, piggyback deposit media, image too light, image too dark, horizontal streaks, below minimum compressed image size, above maximum compressed image size, excessive spot noise, image out of focus, below minimum compressed rear image size, above maximum compressed rear image size, carbon strip detected, and front to rear image dimension mismatch.

12. A method according to claim 10, wherein the field presence parameter comprises one or more of: courtesy amount presence, legal amount presence, date presence, payee name presence, signature presence, codeline presence, payor name and address presence, memo line presence, payor bank name presence, and payee endorsement presence.

13. A method according to claim 10, wherein the field recognition parameter comprises one or more of: codeline and amount.

14. A method according to claim 10, wherein the image parameter may be adjusted.

15. A computer-readable medium having computer-readable code executable by at least one processor of an ATM to perform the method according to claim 1.

16. A system for resolution of deposit transaction exceptions comprising:
a deposit management system comprising a data storage maintaining a plurality of deposit transaction data records, a communication subsystem for communicating over a network with one or more ATMs, and a processor coupled to the data storage and the communication subsystem, wherein the processor is configured to respond to queries of the data storage received at the communication subsystem; and
each ATM comprises a display, an image scanner, an input device, an ATM communication subsystem, and an ATM processor coupled to the display, the image scanner, the input device, and the ATM communication subsystem, wherein the ATM processor is configured to;
receive a request to fulfill a self-service deposit transaction;
scan a deposit media to generate an image of the deposit media;
detect an exception in relation to the deposit transaction;
generate a deposit transaction data record comprising the image and a transaction summary; and
transmit the deposit transaction data record to the deposit management system.
